(19) United States
(12) Patent Application Publication
(10) Pub. No.: US 2012/0161546 A1
(43) Pub. Date: Jun. 28, 2012

(54) POWER CONTROLLER, EXTERNAL DEVICE, AND OPERATING METHOD THEREOF

(75) Inventor: Ji Sung JUNG, Yeongi-gun (KR)

(73) Assignee: Electronics and Telecommunications Research Institute, Daejeon (KR)

(21) Appl. No.: 13/292,763

(22) Filed: Nov. 9, 2011

(30) Foreign Application Priority Data
Dec. 22, 2010 (KR) 10-2010-0132718

(51) Int. Cl. H01H 35/00

(52) U.S. Cl. 307/116

(57) ABSTRACT

An external device including a communication device, a power supply, and a power controller is provided. The communication device communicates with a host system through an interface and the power supply provides power to the communication device. The power controller determines an operation of the power supply as one among a normal operation mode, a power saving mode, and a power cut-off mode based on whether there is a signal through the interface.

### CROSS-REFERENCE TO RELATED APPLICATION

This application claims priority to and the benefit of Korean Patent Application No. 10-2010-0132718 filed in the Korean Intellectual Property Office on Dec. 22, 2010, the entire contents of which are incorporated herein by reference.

### BACKGROUND OF THE INVENTION

(a) Field of the Invention

The present invention relates to a power controller, an external device, and an operating method thereof. Particularly, the present invention relates to a power controller for controlling power of an external device when the power of a host system is cut off, an external device, and an operating method of the external device.

(b) Description of the Related Art

Recently, most host systems have had an interface for use of an external device. For example, there is an interface such as a USB (universal serial bus) and an IEEE 1394 interface.

An external device connected to these interfaces includes a device requiring a low power supply, which may be supplied with power through an interface of a host system. An external device for requiring a high power supply has to be supplied with power through alternating current (AC) power.

An external device that is supplied with power from a host system stops working when the main power of the host system is off or when the interface connected to the host system is disconnected. An external device that is supplied AC power, however, continues to be supplied with power even though when the main power of the host system is off or when the interface connected to the host system is separated, thereby wasting power. In addition, as the external device continues driving, the device is rapidly deteriorated.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method for controlling power having advantages of preventing waste of power and delaying deterioration of an external device by controlling power of the external device when power of a host system is cut off.

An exemplary embodiment of the present invention provides a method for operating an external device. The method includes determining whether there is an interface signal for a communication with a host system, and transiting an operation mode of the external device to a power saving mode when it is not determined that there is the interface signal during a first time interval in a normal operation mode.

Here, the interface signal may correspond to a signal transmitted from the host system to the external device.

The method may further include transiting the operation mode of the external device to a power cut-off mode when it is not determined that there is an interface signal during a second time interval in the power saving mode.

The method may further include transiting the operation mode of the external device to the normal operation mode when it is determined that there is an interface signal during a third time interval in the power saving mode.

The method may further include maintaining the operation mode of the external device with the normal operation mode when it is determined that there is an interface signal during a fourth time interval in the normal operation mode.

The first time interval, the second time interval, the third time interval, and the fourth time interval may be the same. Otherwise, the first time interval and the second time interval may be different.

Another exemplary embodiment of the present invention provides a power controller for an external device. The power controller includes a signal checking unit for checking whether there is an interface signal for communication with a host system, and a mode determining unit for transiting an operation mode of the external device to a power saving mode when there is no interface signal during a predetermined time interval in a normal operation mode.

Here, the interface signal may correspond to a signal transmitted from the host system to the external device.

The mode determining unit may transit the operation mode of the external device to a power cut-off mode when there is no interface signal during a predetermined time interval in the power saving mode.

The mode determining unit may transit the operation mode of the external device to the normal operation mode when there is an interface signal during a predetermined time interval in the power saving mode. In addition, the mode determining unit may maintain the operation mode of the external device with the normal operation mode when there is an interface signal during a predetermined time interval in the normal operation mode.

Yet another exemplary embodiment according to the present invention provides an external device. The external device includes a communication device for communicating with a host system through an interface; a power supply for providing power to the communication device; and a power controller for controlling the power supply to be operated in a power saving mode when there is no signal through the interface during a predetermined time interval in a normal operation mode.

The power controller may control the power supply to be operated in a power cut-off mode when there is no signal through the interface during a predetermined time interval in the power saving mode.

The power controller may control the power supply to be operated in the normal operation mode when there is a signal through the interface during a predetermined time interval in the power saving mode.

The power controller may control the power supply to maintain the operation mode of the external device with the normal operation mode when there is a signal through the interface during a predetermined time interval in the normal operation mode.

### BRIEF DESCRIPTION OF THE DRAWINGS

FIG. 1 shows a block diagram that represents a construction of an external device according to an exemplary embodiment of the present invention and a connection between the external device and a host system.

FIG. 2 shows a transition of an operation mode according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Through the specification, in addition, unless explicitly described to the contrary, the word “comprise” and variations such as “comprises” or “comprising” will be understood to imply the inclusion of stated elements but not the exclusion of any other elements.

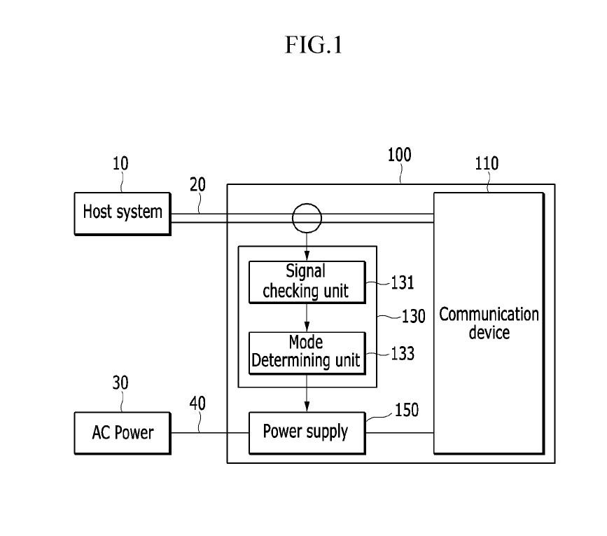

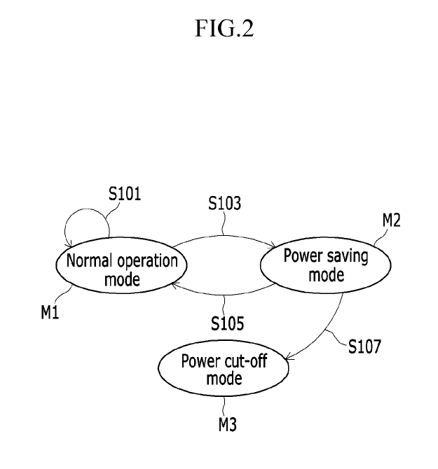

An external device and a method for operating the external device according to an exemplary embodiment of the present invention will be described with reference to FIG. 1 and FIG. 2.

First, referring to FIG. 1, an external device according to an exemplary embodiment of the present invention will be described.

FIG. 1 shows a block diagram that represents a construction of an external device according to an exemplary embodiment of the present invention and a connection between the external device and a host system

As shown in FIG. 1, an external device 100 is connected to a host system 10 via an interface line 20, and is also connected to alternating current (AC) power 30 via a power line 40. The external device 100 includes a communication device 110, a power controller 130, and a power supply 150. The power controller 130 includes a signal checking unit 131 and a mode determining unit 133.

The communication device 110 is supplied with power from the power supply 150 and communicates with the host system 10 through the interface line 20. The communication device 110 may be an external hard disk, an external memory, an external wireless local area network (WLAN) apparatus, and others.

The signal checking unit 131 checks a signal of the interface line 20, generates a check signal based on whether there is a signal of the interface line 20, and provides the check signal to the mode determining unit 133. The signal checking unit 131 may check whether there is a signal transmitted from the host system 10 to the communication device 110 at the interface line 20 and may generate a check signal based on the result of checking.

The mode determining unit 133 determines an operation mode of the external device 10 by using the check signal from the signal checking unit 131.

The power supply 150 generates stable power from the AC power through the power line 40 and provides the stable power to the communication device 110.

The mode determining unit 133 according to an exemplary embodiment of the present invention will be described with reference to FIG. 2.

FIG. 2 shows a transition of an operation mode according to an exemplary embodiment of the present invention.

It is assumed that the external device 100 initially operates in a normal operation mode M1.

In the normal operation mode M1, the mode determining unit 133 checks a check signal during a first time duration to determine whether there is a signal on the interface line 20. When it is determined that there is a signal on the interface line 20 during the predetermined time interval, that is, the first time interval in the normal operation mode M1, the mode determining unit 133 maintains the operation mode of the external device 100 with the normal operation mode M1 (S101).

Meanwhile, when it is not determined that there is a signal on the interface line 20 during a second time interval in the normal operation mode M1, the mode determining unit 133 transits the operation mode of the external device 100 into a power saving mode M2 and provides a mode control signal to the power supply 150 to be operated in the power saving mode M2 (S103).

When it is determined that there is a signal on the interface line 20 during a third time interval in the power saving mode M2, the mode determining unit 133 transits the operation mode of the external device 100 into the normal operation mode M1 and provides a mode control signal to the power supply 150 so that the power supply 150 operates in the normal operation mode M1 (S105).

Meanwhile, when it is not determined that there is a signal on the interface line 20 during a fourth time interval in the power saving mode M2, the mode determining unit 133 transits the operation mode of the external device 100 into a power cut-off mode M3 and provides a mode control signal to the power supply 150 so that the power supply 150 operates in the power cut-off mode M3 (S107). The power supply in the power cut-off mode M3 does not provide power to the communication device 110.

Here, the first time interval to the fourth time interval may be the same length or may be different lengths.

According to the exemplary embodiments of the prevent invention, a power controller is inserted in the device using AC power among devices connected to an external interface of a host system to control the AC power of the device when a signal from the host system is disconnected. Therefore, it prevents a waste of power by cutting off the power to the external device when not in use and minimizes deterioration of the external device caused by continued operation.

The above-mentioned exemplary embodiment of the present invention is not embodied only by an apparatus and method. Alternatively, the above-mentioned exemplary embodiment may be embodied by a program performing functions that correspond to the configuration of the exemplary embodiment of the present invention, or a recording medium on which the program is recorded.

While this invention has been described in connection with what is presently considered to be a practical exemplary embodiment, it is to be understood that the invention is not limited to the disclosed embodiment, but, on the contrary, is intended to cover various modifications and equivalent arrangements included within the spirit and scope of the appended claims.

What is claimed is:

1. A method for operating an external device, comprising:
determining whether there is an interface signal for communication with a host system; and
transiting an operation mode of the external device to a power saving mode when it is not determined that there is the interface signal during a first time interval in a normal operation mode.

2. The method of claim 1, wherein the interface signal corresponds to a signal transmitted from the host system to the external device.

3. The method of claim 2, further comprising
transiting the operation mode of the external device to a power cut-off mode when it is not determined that there is an interface signal during a second time interval in the power saving mode.

4. The method of claim 3, further comprising
transiting the operation mode of the external device to the normal operation mode when it is determined that there is an interface signal during a third time interval in the power saving mode.

5. The method of claim 4, further comprising
maintaining the operation mode of the external device with the normal operation mode when it is determined that there is an interface signal during a fourth time interval in the normal operation mode.

6. The method of claim 5, wherein the first time interval, the second time interval, the third time interval, and the fourth time interval are the same.

7. The method of claim 3, wherein the first time interval and the second time interval are different.

8. A power controller for an external device, comprising:
a signal checking unit for checking whether there is an interface signal for communication with a host system; and
a mode determining unit for transiting an operation mode of the external device to a power saving mode when there is no interface signal during a predetermined time interval in a normal operation mode.

9. The power controller of claim 8, wherein the interface signal corresponds to a signal transmitted from the host system to the external device.

10. The power controller of claim 9, wherein the mode determining unit transits the operation mode of the external device to a power cut-off mode when there is no interface signal during a predetermined time interval in the power saving mode.

11. The power controller of claim 10, wherein the mode determining unit transits the operation mode of the external device to the normal operation mode when there is an interface signal during a predetermined time interval in the power saving mode, and
wherein the mode determining unit maintains the operation mode of the external device with the normal operation mode when there is an interface signal during a predetermined time interval in the normal operation mode.

12. An external device, comprising:
a communication device for communicating with a host system through an interface;
a power supply for providing power to the communication device; and
a power controller for controlling the power supply to be operated in a power saving mode when there is no signal through the interface during a predetermined time interval in a normal operation mode.

13. The external device of claim 12, wherein the power controller controls the power supply to be operated in a power cut-off mode when there is no signal through the interface during a predetermined time interval in the power saving mode.

14. The external device of claim 13, wherein the power controller controls the power supply to be operated in the normal operation mode when there is a signal through the interface during a predetermined time interval in the power saving mode.

15. The external device of claim 14, wherein the power controller controls the power supply to maintain the operation mode of the external device with the normal operation mode when there is a signal through the interface during a predetermined time interval in the normal operation mode.
